(19) United States
(12) Patent Application Publication
(10) Pub. No.: US 2020/0255282 A1
(43) Pub. Date: Aug. 13, 2020

(54) BRIDLE FOR HORSES

(71) Applicant: AMAHORSE TRADING S.r.l., San Giustino (Perugia) (IT)

(72) Inventor: Mauro BENETTI, Lonato del Garda (Brescia) (IT)

(21) Appl. No.: 16/642,418

(22) PCT Filed: Sep. 3, 2018
(86) PCT No.: PCT/IB2018/056711

§ 371 Date: Feb. 27, 2020

(30) Foreign Application Priority Data
Sep. 1, 2017 (IT) 102017000098438

(51) Int. Cl. B68B 1/04; B68B 1/02

(52) U.S. Cl. CPC B68B 1/04; B68B 1/02

(57) ABSTRACT

A bridle for horses including a noseband, or flash, a crownpiece, and a pair of cheekpieces connecting the crownpiece to the noseband is provided. The lower end of each cheekpiece is fixed to a connecting fork sliding freely along a sliding pin fixed to the side of the noseband.

The present invention concerns a bridle for horses.

As is known, the bridle is a harness used to communicate with the horse and to control it. The bridle is fitted around the horse's head and is generally used to support the bit.

The bridle is made up of strips of leather, nylon or other composite synthetic materials; various buckles allow the length of the bridle elements to be fitted perfectly to the measurements of the horse's head; other buckles, at the ends of the various segments, allow the loops to be closed and the bridle to be connected to the bit.

Generally a bridle comprises a noseband, or flash, that encircles the muzzle of the horse, a crownpiece, or headstall, that forms a loop that passes around the poll of the horse, and a pair of cheekpieces, or cheek straps, consisting of buckles of adjustable length that connect the crownpiece to the noseband.

These cheekpieces pass close to the eyes and cheekbones of the horse. The lower end of each cheekpiece must therefore be able to slide along the noseband in such a way as to allow the cheekpiece to be correctly positioned along the muzzle of the horse.

In one known embodiment, the end of the cheekpiece forms an eyelet through which the noseband passes.

However, the friction between the leather of the cheekpiece and the leather of the noseband prevents a free sliding of the cheekpiece and therefore no self-adjustment of the position of the cheekpiece is possible.

The object of the present invention is to propose a bridle that allows such a drawback to be resolved, and, in particular, that allows a self-adjustment of the position of the cheekpiece.

Another object of the invention is to propose a bridle that is particularly comfortable for the horse.

These objects are achieved with a bridle for horses according to claim 1. The dependent claims describe preferred embodiments of the invention.

The features and advantages of the bridle according to the invention will, however, become evident from the description provided hereinafter of the preferred embodiments thereof, provided by way of indicative and non-limiting examples, with reference to the accompanying figures, wherein:

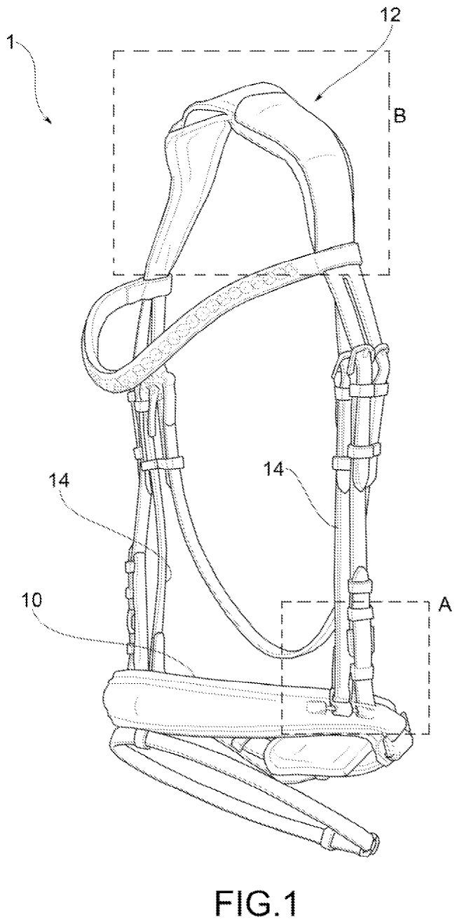

FIG. 1 shows a bridle for horses according to the invention;

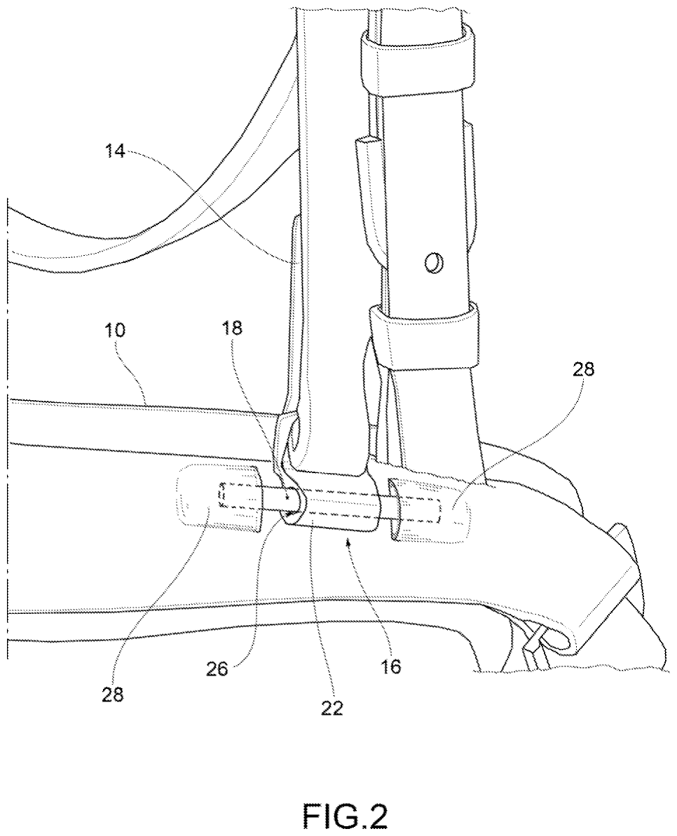

FIG. 2 is an enlarged view of the detail A of FIG. 1;

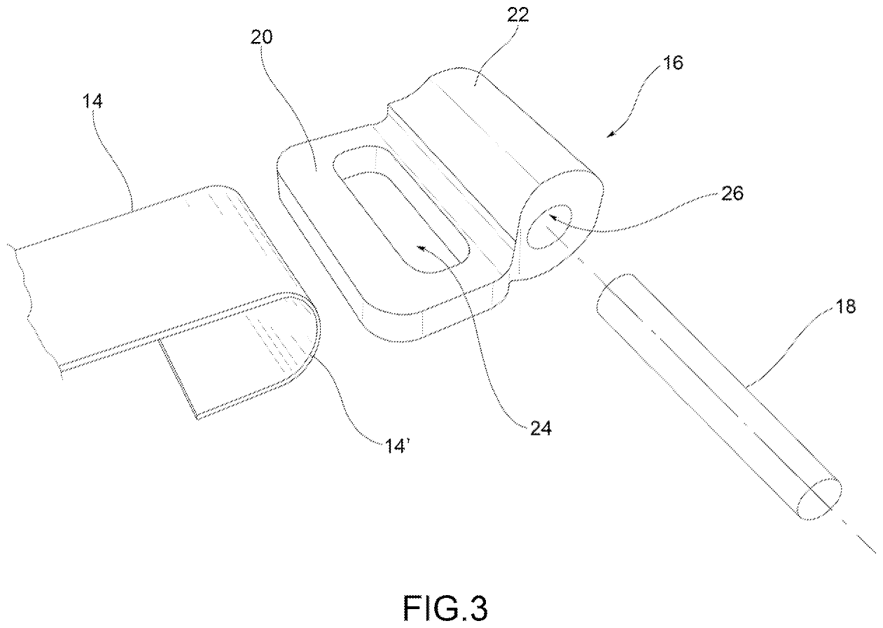

FIG. 3 is an exploded view of the elements connecting a cheekpiece to the noseband; and

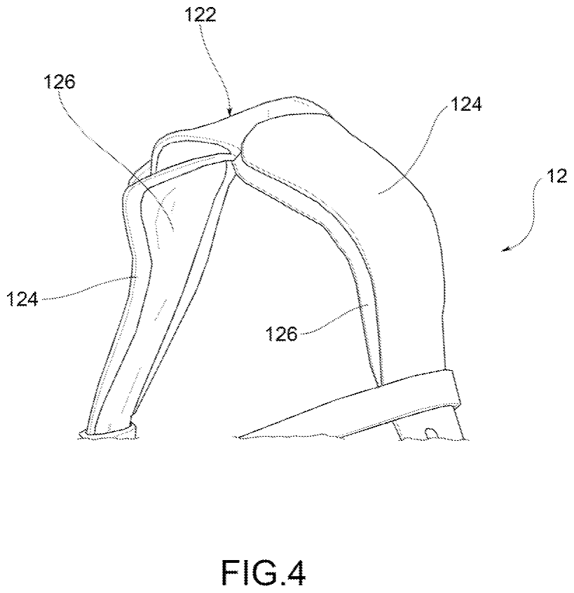

FIG. 4 is an enlarged view of the detail B of FIG. 1;

In said drawings, a bridle for horses according to the invention has been indicated collectively at 1.

The bridle 1 comprises a noseband 10, or a flash, consisting of an annular buckle, preferably made of leather, that encircles the muzzle of the horse. At the top, the bridle 1 comprises a crownpiece 12, or headstall, which forms a loop suitable for passing around the poll of the horse. A pair of cheekpieces 14, or cheek straps, consisting of buckles of adjustable length, connect the lower ends of the crownpiece 12 to side portions of the noseband 10.

According to one aspect of the invention, the lower end of each cheekpiece 14 is fastened to a respective connecting fork 16, freely sliding along a sliding pin 18, fastened laterally to the noseband 10.

In the following description, the term “sliding pin” means a substantially straight stem or shaft element, preferably made of a rigid material, on which the connecting fork 16 slides so as to be translatable in a substantially straight direction.

More specifically (FIG. 3), the connecting fork 16 comprises a cheekpiece coupling portion 20 and a sliding portion 22. In the cheekpiece coupling portion 20 there is a slot 24 in which an eyelet 14′ formed at the lower end of the cheekpiece 14 passes. A through-hole 26 is made in the sliding portion 22 into which is slidably inserted the sliding pin 18.

The sliding pin 18 may be attached in various ways to the outer side of the side portion of the noseband 10.

For example, the end portions of the sliding pin 18 are inserted into respective pockets 28 made in the noseband 10.

In other words, the sliding pin 18 may be partially inserted into the noseband 10 but has a central exposed portion so as to be slidably accommodated within the through-hole 26 of the connecting fork 16.

However, the sliding pin 18 is fixed to the noseband 10 so that it extends tangentially, i.e. parallel to the annular direction of extension of the noseband 10. The sliding pin 18 thus extends substantially orthogonally to the respective cheekpiece 14 in a plane wherein lies the same cheekpiece 14.

In other words, when the noseband 10 is placed around the muzzle of the horse, the sliding pin 10 is parallel to the respective cheek of the horse.

In a preferred embodiment, the cheekpieces 14 and the noseband 10 are made of leather, while the connecting fork 16 and the sliding pin 18 are made of metal or plastic.

In any case, the lower end of the cheekpiece 14 is free to slide with respect to the noseband for self-adjustment of the position of the cheekpieces according to the anatomy of the horse's head and/or the movements of the same head.

In other words, the lower end of each cheekpiece 14 is free to translate along a straight line corresponding to the axis of the sliding pin 18.

Therefore, the lower end of each cheekpiece 14 enjoys a certain degree of freedom when connecting to the noseband 10 in such a way that each cheekpiece 14, while remaining close to the respective cheek of the horse's muzzle, may be tilted forward or backward with respect to a central position wherein it is substantially perpendicular to the noseband 10.

Moving on to the upper part of bridle 1, the crownpiece 12 comprises a top portion 122 and two side portions 124 that extend inferiorly from the top portion 122 and the ends of which are connected to the cheekpieces 14.

According to another aspect of the invention, these side portions 124 are provided with a padding 126 facing the horse.

Such padding is interrupted on the underside of the top portion 122. In other words, the top portion is unpadded and therefore of reduced thickness.

In particular, the padding 126 is of such thickness and/or density whereby, when the bridle is positioned around the horse's head, the top portion 122 does not rest on the horse's poll.

In effect, the poll of the horse is rich in nerves and the possibility of discharging the weight of the bridle 1 onto the padded side portions 124 allows the welfare of the animal to be greatly increased.

To the embodiments of the bridle according to the invention, a person skilled in the art may, to satisfy contingent needs, make modifications, adaptations and replacements of elements with others that are functionally equivalent, without departing from the scope of the following claims. Each of the features described as belonging to a possible embodiment may be implemented independently from the other described embodiments.

1. A bridle for horses, comprising a noseband or flash, a crownpiece, and a pair of cheekpieces connecting the crownpiece to the noseband, wherein a lower end of each cheekpiece is secured to a respective connecting fork sliding freely along a sliding pin fixed laterally to the noseband.

2. The bridle to of claim 1, wherein the sliding pin extends tangentially, parallel to an annular direction of extension of the noseband.

3. The bridle of claim 1, wherein the connecting fork comprises a cheekpiece coupling portion provided with a slot in which passes an eyelet formed at the lower end of each cheekpiece, and a sliding portion provided with a hole in which the sliding pin is slidably inserted.

4. The bridle of claim 1, wherein end portions of the sliding pin are inserted into respective pockets formed in the noseband.

5. The bridle of claim 1, wherein the pair of cheekpieces and the noseband are made of leather, and wherein the connecting fork and the sliding pin are made of metal or plastic material.

6. The bridle of claim 1, wherein the crownpiece comprises a top portion and two side portions extending inferiorly from said top portion, and wherein said two side portions are provided with a padding facing the horse, said padding being interrupted along an underside of the top portion and having a thickness and/or a density such that when the bridle is positioned around the horse's head, the top portion does not rest on the horse's poll.

7. A bridle for horses, comprising a noseband or flash, a crownpiece and a pair of cheekpieces connecting the crownpiece to the noseband, wherein the crownpiece comprises a top portion and two side portions extending inferiorly from said top portion, wherein said two side portions are provided with a padding facing the horse, said padding being interrupted along an underside of the top portion and having a thickness and/or a density such that when the bridle is positioned around the horse's head, the top portion does not rest on the horse's poll.
